(19) United States
(12) Patent Application Publication
(10) Pub. No.: US 2018/0002070 A1
(43) Pub. Date: Jan. 4, 2018

(54) TRANSPARENT DISCHARGING PLATE FOR PROVIDING INFORMATION DELIVERY FUNCTION AND PREVENTING FOREIGN SUBSTANCES FROM INFILTRATING INTO BOTTOM THEREOF

(71) Applicant: PUM-TECH KOREA CO., LTD, Incheon (KR)

(72) Inventor: Do Hoon LEE, Incheon (KR)

(21) Appl. No.: 15/626,478

(22) Filed: Jun. 19, 2017

(30) Foreign Application Priority Data
Jun. 30, 2016 (KR) 10-2016-82924
Jul. 28, 2016 (KR) 10-2016-95866

(51) Int. Cl. B65D 25/54; A45D 40/00; A45D 40/22; B05B 11/00

(52) U.S. Cl. CPC B65D 25/54; B05B 11/3002; A45D 40/0075; A45D 40/22; A45D 2040/0012

(57) ABSTRACT

The present invention relates to a compact container having a transparent discharging plate for providing an information transmission function and preventing foreign substances from infiltrating into a bottom thereof, in which the compact container includes a discharging device, the discharging device is formed at a top thereof with a distribution plate, a palette, and a transparent discharging plate, various characters or images are printed on a bottom of the transparent discharging plate, and the palette is formed on a lower side of the transparent discharging plate through an insert-injection molding or a double-injection molding, thus the characters or images are projected onto a top of the transparent discharging, plate when the compact container is opened, so that information, on the compact being used is delivered to the consumer, the aesthetics is visually improved, and the characters or images are prevented from being contaminated by a discharged cosmetic material.

### CROSS-REFERENCE TO RELATED APPLICATION

This application claims the benefit of Korean application No. 10-2016-82924 filed on Jun. 30, 2016, and Korean application No. 10-2016-95866 filed on Jul. 28, 2016 with the Korean intellectual Property Office, the disclosure of which is incorporated herein by reference.

### BACKGROUND OF THE INVENTION

### Field of the Invention

The present invention relates to a compact container having a transparent discharging plate for providing an information delivery function and preventing foreign substances from infiltrating into a bottom thereof, and more specifically, to a compact container having a transparent discharging plate for providing an information transmission, function and preventing foreign substances from infiltrating into a bottom thereof, in which the compact container is provided therein with a discharging device for discharging a cosmetic material to the outside, and the discharging device is formed at a top thereof with a distribution plate, a palette, and a transparent discharging plate formed, of a transparent or translucent material, various characters or images are printed on a bottom of the transparent discharging plate, and the palette is formed on a lower side of the transparent discharging plate through an insert-injection molding or a double-inject ion molding, thus the characters or images are projected onto a top of the transparent discharging plate when the compact container is opened, so that information on the compact being used is delivered to the consumer, the visual, aesthetics is improved, and the characters or images are prevented from being contaminated by a discharged cosmetic material.

### Description of the Related Art

In general, women use color cosmetic products to express a skin color beautifully, conceal defects of a skin, and protect the skin from pollutions, dusts and ultraviolet rays.

The color cosmetic products are mainly classified into a powder-type product and a gel-type foundation. Because contents of the powder-type powder product are scattered during use, and the adhesion onto a face is lowered when the powder-type powder product is applied to the face, the uses of the gel-type foundation have been gradually increasing.

The foundation is prepared by mixing ingredients such as a binder and an emulsifier into a color powder raw material, melting and cooling the mixture at a predetermined temperature, and storing or carrying the contents in a cosmetic container such as a compact container, and is used with a makeup tool such as a puff.

However, since the conventional compact container accommodates the cosmetic material in the container or incorporates a sponge impregnated therein with the cosmetic material, and the cosmetic material or the sponge is directly drawn by the puff, there is a problem in that unnecessary cosmetic material put on the puff is wasted according to the pressure applied by the user onto the cosmetic material or the sponge.

In addition, the conventional compact container is used in the manner that the cosmetic material impregnated in the sponge is put on the puff to makeup while making contact with a skin such as a face, and when the puff repeatedly presses and makes contact with the sponge impregnated therein with the cosmetic material, the cosmetic material is contaminated due to virus, fungi and bacteria present on the skin.

Accordingly, it is under development of a compact container capable of using the cosmetic material in a fixed amount and preventing the cosmetic material from being contaminated by blocking the contact between the puff and the cosmetic material accommodated in the container.

The related art, as shown in FIG. 1, has been disclosed Korean Patent Publication No. 10-2015-0096605, The conventional compact container includes: a discharging unit for discharging a cosmetic material to the outside; and a discharging plate provided at one side of the discharging unit from which the cosmetic material is discharged, and including a plurality of discharging holes, thus the cosmetic material is discharged by a predetermined amount each time, and the direct contact between the cosmetic material and puff is prevented, so that the cosmetic material can be prevented from being contaminated.

Characters or patterns are printed on a top surface or a bottom surface of the compact lid of the conventional compact container to deliver information to a user or satisfy visual aesthetics. However, because the user opens the compact lid upon makeup, the information about the compact cannot be delivered during the makeup.

Further, in the conventional compact container, when the characters or patterns are printed on a surface of the discharging plate, the printing ink used thereon may be dissolved by the discharged cosmetic material, thereby contaminating the cosmetic material, as a result, expressions, such as characters or images printed on the discharging plate may be erased.

In order to solve the problems, as shown in FIG. 2, the applicant of the present invention has filed and registered Korean Utility Model Registration No. 20-0480439 with respect to a compact container for a gel-type cosmetic material provided therein with a pattern-printed information delivery plate, in which the conventional compact container includes a transparent discharging plate 1, and an information delivery plate printed thereon with characters or patterns is fitted into a lower portion of the transparent discharging plate 1, so that information about the compact can be delivered to the consumer.

However, according to the conventional compact container, when the cosmetic material is discharged, the cosmetic material is infiltrated into a gap between the transparent discharging plate 1 and the assembled information delivery plate 2, and the patterns or characters printed on the information delivery plate 2 is covered by the cosmetic material, thus the information delivery function, is insufficiently performed, and it becomes dirty visually.

In addition, because the conventional compact container is required to be assembled by additionally inserting the information delivery plate 2 between the transparent discharging plate 1 and a support plate 3, an assembling process for inserting the information delivery plate 2 is increased, thereby decreasing the productivity, thus manufacturing costs are increased.

### SUMMARY OF THE INVENTION

To solve the above problems, the present invention provides a compact container having a transparent discharging plate for providing an information transmission function and preventing foreign substances from infiltrating into a bottom thereof, in which the compact container is formed therein with a discharging device for discharging a cosmetic material to the outside, the discharging device is formed at a top thereof with a distribution plate, a palette, and a transparent discharging plate which is formed of a transparent or translucent material, various character's or images are printed on a bottom of the transparent discharging plate, and the palette is formed on a lower side of the transparent discharging plate through an insert-injection molding or a double-injection molding, thus the characters or images are projected onto a top of the transparent discharging plate when the compact container is opened, so that information on the compact being used is delivered to the consumer, the aesthetics is visually improved, and the characters or images are prevented from being contaminated by a discharged cosmetic material.

In addition, The present invention is to provide a compact container having a transparent discharging plate for providing an information transmission function and preventing foreign substances from infiltrating into a bottom thereof, in which various characters or images are printed on a bottom surface of a transparent plate, the palette is formed on a lower side of the transparent discharging plate through insert-injection molding or double-injection molding, and a distribution plate, is formed to a bottom side of the palette through ultrasonic-bonding, thereby forming one component coupled to the top of a discharging device, thus an assembling structure of the compact container is simplified, so that the productivity is improved.

The present invention provides a compact container having a transparent discharging plate for providing an information transmission function and preventing foreign substances from infiltrating into a bottom thereof, in which the compact container includes; a distribution plate (50) provided therein with a distribution passage (52); a palette (60) formed on a top of the distribution plate (50), and provided therein with a discharging passage (62); and a transparent discharging plate (70) formed on an upper portion of the palette 60, provided therein with discharging holes (72), and formed of a transparent or translucent material, wherein images or characters are printed on a bottom of the transparent discharging plate (70) and projected onto a top of the transparent discharging plate (70), the palette (60) is formed on a lower side of the transparent discharging plate (70) through an insert-injection molding or a double-injection molding, and the distribution plate (50) is coupled to a lower side of the palette (60) thereby forming a single component.

In addition, the distribution plate (50), the palette (60) and the transparent discharging plate (70) are adjacently coupled to a discharging device (40) for discharging the cosmetic material accommodated in a contents container (30).

In addition, the discharging device (40) may be a pump for pumping the cosmetic material.

In addition, the distribution plate (50) may be formed on an upper surface; thereof with a fitting annular groove (54), and a fitting protrusion wheel (64) formed on a lower surface of the palette (60) may be fitted into the fitting annular groove (54).

In addition, the distribution plate (50) may be formed on an upper surface thereof with a fitting groove (56), and the palette (60) formed on a lower surface thereof with a fitting protrusion (66) may be fitted into the fitting groove (56).

In addition, the distribution plate (50) may be bonded to the lower side of the palette (60) through ultrasonic bonding, RF bonding or thermal bonding, or bonded by an adhesive.

In addition, the palette (60) is formed of an opaque material.

In addition, the transparent discharging plate (70) is formed on an upper side thereof with a rim member (61), in which the rim member (61) is formed on the transparent discharging plate (70) through an insert-injection bonding or a double-injection bonding simultaneously with the palette (60).

According to the present invention, in the compact container having a transparent discharging plate for providing an information transmission function and preventing foreign substances from infiltrating into a bottom thereof, the compact container is formed therein with a discharging device for discharging a cosmetic material to the outside, the discharging device is formed at a top thereof with a distribution plate, a palette, and a transparent discharging plate which is formed of a transparent or translucent material, various characters or images are printed on a bottom of the transparent discharging plate, and the palette is formed on a lower side of the transparent discharging plate through an insert-injection molding or a double-injection molding, thus the characters or images are projected onto a top of the transparent discharging plate when the compact container is opened, so that information on the compact being used can be delivered to the consumer, the aesthetics can be visually improved, and the characters or images can be prevented from being contaminated by a discharged cosmetic material.

Further, according to the present invention, in the compact container having a transparent discharging plate for providing an information transmission function and preventing foreign substances from infiltrating into a bottom thereof, various characters or images are printed on a bottom surface of a transparent plate, the palette is formed on a lower side of the transparent discharging plat(c) through insert-injection molding or double-injection molding, and a distribution plate is bonded to a bottom side of the palette through ultrasonic-bonding, thereby forming one component coupled to a top of a discharging device, thus an assembling structure of the compact container can be simplified, so that the productivity can be improved.

### BRIEF DESCRIPTION OF THE DRAWINGS

FIG. 1 is a view showing a conventional compact container.

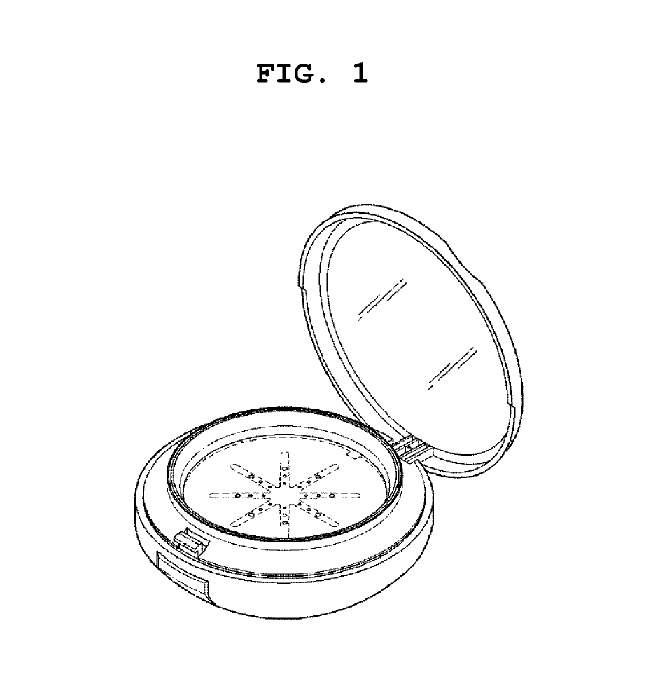

FIG. 2 is a view showing a conventional compact container for a gel-type cosmetic material, which is provided therein with a pattern-printed information delivery plate.

FIG. 3 is a perspective view showing a compact container having; a transparent discharging plate for providing an information delivery function and preventing foreign substances from infiltrating into a bottom thereof according to the present invention.

FIG. 4 is an exploded perspective view showing a compact container having a transparent discharging plate for providing an information delivery function and preventing foreign substances from infiltrating into a bottom thereof according to the present invention.

FIG. 5 is a sectional view showing a compact container having a transparent discharging plate for providing an information delivery function and preventing foreign substances from infiltrating into a bottom thereof according to the present invention.

FIG. 6 is a sectional view showing a state of discharging a cosmetic material onto a transparent discharging plate of a compact container having a transparent discharging plate fox providing an information delivery function and preventing foreign substances from infiltrating into a bottom thereof according to the present invention.

FIG. 7 is a sectional view showing a state of introducing a cosmetic material into a cylinder of a compact container having a transparent discharging plate for providing an information delivery function and preventing foreign substances from infiltrating into a bottom thereof according to the present invention.

FIG. 8 is a sectional view showing a state a palette, a rim member, and a transparent discharging plate are insert-injected or double-injected of a compact container having a transparent discharging plate for providing an information delivery function and preventing foreign substances from infiltrating into a bottom thereof according to the present invention.

FIG. 9 is a sectional view showing a state of a distribution plate coupled to a lower side of the palette of a compact container having a transparent discharging plate for providing an information delivery function and preventing foreign substances from infiltrating into a bottom thereof according to the present invention.

### DETAILED DESCRIPTION OF THE INVENTION

Hereinafter, an embodiment of a compact container having a transparent discharging plate for providing an information delivery function and preventing foreign substances from infiltrating into a bottom thereof according to the present invention will be described with reference to the accompanying drawings.

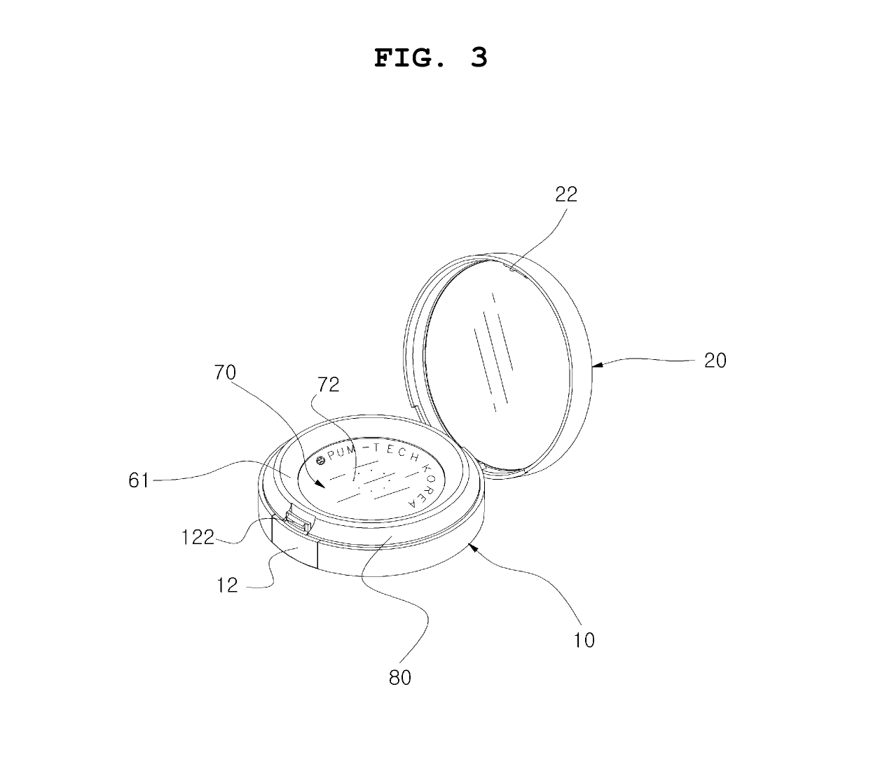

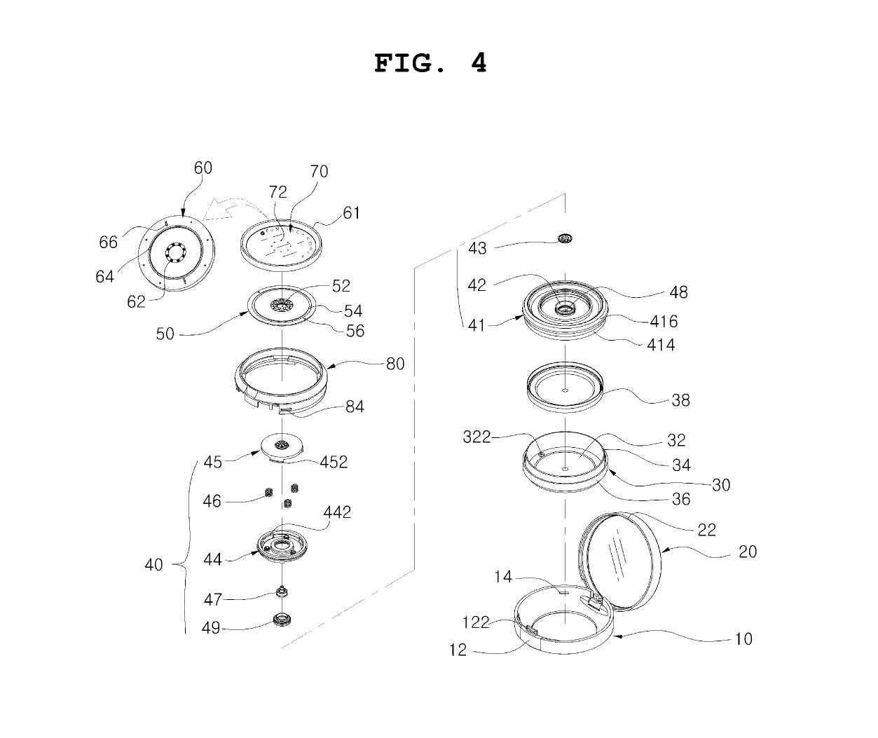

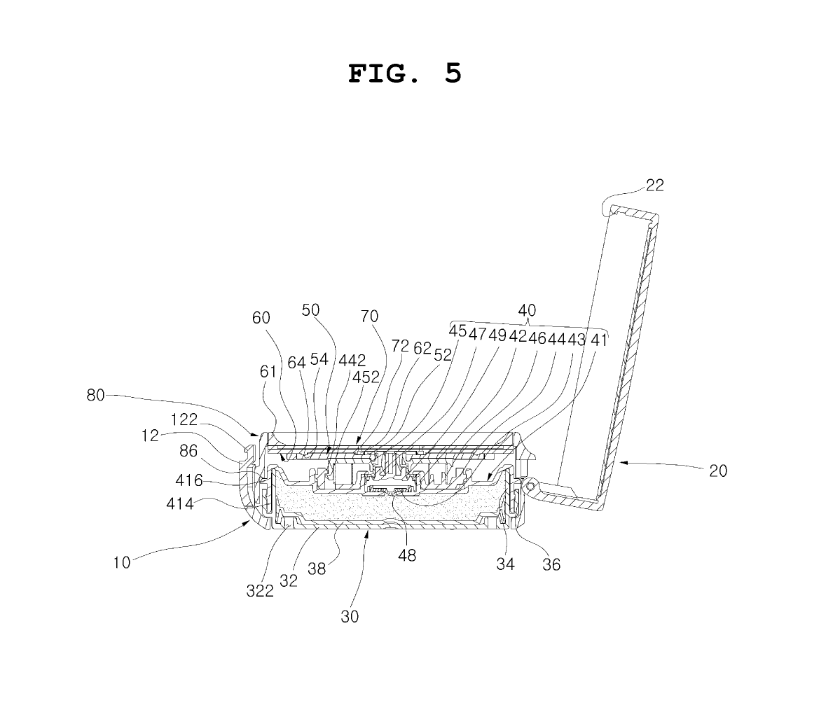

FIG. 3 is a perspective view showing a compact container having a transparent discharging plate for providing an information delivery function and preventing foreign substances from infiltrating into a bottom thereof according to the present invention. FIG. 4 is an exploded perspective view of a compact container having a transparent discharging plate for providing an information delivery function and preventing foreign substances from infiltrating into a bottom thereof according to the present invention. FIG. 5 is a sectional view showing a compact container having a transparent discharging plate for providing an information delivery function and preventing foreign substances from infiltrating into a bottom thereof according to the present invention.

The compact container having a transparent discharging plate for providing an information, delivery function and preventing foreign substances from infiltrating into a bottom thereof according to the present invention includes: a distribution plate 50 provided therein with a distribution passage 52; a palette 60 formed on a top of the distribution plate 50, and provided therein, with a discharging passage 62; and a transparent discharging plate 70 formed on an upper portion of the palette 60, provided therein with discharging holes 72, and formed of a transparent or translucent material, in which images or characters are printed on a bottom of the transparent discharging plate 70 and projected onto a top of the transparent discharging plate 70, the palette 60 is formed on a lower side of the transparent discharging plate 70 through an insert-injection molding or a double-injection molding, and the distribution plate 50 is coupled to a lower side of the palette 60, thereby forming a single component.

In addition, the distribution plate 50, the palette 60 and the transparent discharging plate 70 are adjacently coupled to a discharging device 40 for discharging the cosmetic material accommodated in a contents container 30.

The contents container 30 is mounted inside an outer container 10, and the outer container 10 is coupled at one side thereof with an outer container lid 20 for opening/closing the outer container 10.

The outer container 10 is formed at a front thereof with a button 12, and a latching protrusion 122 retracted by a press action of a user protrudes from an upper portion of the button 12.

A coupling shoulder 80 is coupled to the inside of the outer container 10, in which the coupling shoulder 80 presses a pump housing 41 of the discharging device 40 to fix the pump housing 41 and the contents container 30 to the inside of the outer container 10 and enable the palette 60 and the transparent discharging plate 70 to move vertically without being slanted when the palette 60 and the transparent discharging plate 70 move up and down.

A pressing sill 86 is formed on an inner periphery of the coupling shoulder 80 to press and fix the pump housing 41 of the discharging device 40.

A coupling protrusion 14 formed on an inner periphery of the outer container 10 is coupled to a coupling groove 84 formed on an outer periphery of the coupling shoulder 80.

The outer container lid 20 is hinged to one side of the outer container 10 to open/close the outer container 10.

The outer container lid 20 is formed on a front portion thereof with a hook 22 in the form of a protrusion, so that the hook 22 is fastened to the latching protrusion 122.

The cosmetic material is accommodated inside the contents container 30, and the contents container 30 is mounted inside the outer container 10.

The contents container 30 includes a bottom surface 32, an inner wall 34 extending upwardly from the bottom surface 32, and an outer wall 36 spaced apart at a predetermined interval and extending upwardly from the inner wall 34.

The contents container 30 is formed in the bottom surface 32 thereof with an air circulation hole 322 into which external air is introduced.

The contents container 30 is formed therein with a lifting plate 38 for upwardly lifting the cosmetic material, and the lifting plate 38 makes tight contact with an inner surface of the contents container 30.

The discharging device 40 is installed on an upper portion of the content container 30 to discharge the cosmetic material accommodated in the contents container 30.

The discharging device may be a pump for pumping and discharging the cosmetic material to the outside.

The discharging device 40 may include a pump housing 41 coupled to an upper portion of the contents container 30, a cylinder 42 formed at a center of the pump housing 41, and formed in a bottom surface thereof with a contents suction hole 48, a suction valve plate 43 mounted on a bottom surface of the cylinder 42 to selectively open/close the contents suction hole 48, a bushing 44 laid on an upper-end of the cylinder 42 and coupled to an outer side of the cylinder 42, an tip/down moving member 45 moving up and down over the bushing 44, an elastic member 46 for plastically supporting the up/down moving member 45, a piston 47 coupled to the up/down moving member 45 to move up and down in the cylinder 42 together with the up/down moving member 45, and a piston ring 49 fitted around an outer side of the piston 47 and making tight contact with an inner surface of the cylinder 42.

The pump housing 41 is coupled to the upper portion of the contents container 30 to seal the contents container 30.

A lower extending protrusion wheel 414 downwardly extending from an outer side of the pump housing 41 is coupled between the inner wall 34 and the outer wall 36 of the contents container 30.

A fix protrusion wheel 416 pressed by the pressing sill 86 of the coupling shoulder 80 is formed on an outer periphery of the lower extending protrusion wheel 414.

A first latching sill 442 formed on the bushing 44 and a second latching sill 452 formed on the up/down moving member 45 are fastened to each other, thereby preventing the up/down moving member 45 from being separated from the bushing 44.

The distribution plate 50 is coupled to the upper portion of the up/down moving member 45 of the discharging device 40, and the distribution plate 50 is formed at a center thereof with a distribution passage 52 for moving the cosmetic material discharged by the discharging device 40.

The distribution plate 50 is formed on an upper surface thereof with a fitting annular groove 54, and the fitting groove 56 is formed on an outer side of the fitting annular groove 54.

The palette 60 is coupled to the upper portion of the distribution plate 50, and the palette 60 is formed therein with a discharging passage 62 for moving the cosmetic material passed through the distribution passage 52 of the distribution plate 50 to the discharging holes 72 of the transparent discharging plate 70.

A fitting protrusion wheel 6:4 is formed on a lower surface of the palette 60, thereby being fitted into the fitting annular groove 54, and the fitting protrusion 66 is formed on an outer side of the fitting protrusion wheel 64, thereby being fitted into the fitting groove 56 of the distribution plate 50.

The distribution plate 50 may be coupled to the lower side of the palette 60 by bonding through ultrasonic-bonding, RF bonding, or thermal-bonding, or bonded by an adhesive, or may be undercut-coupled.

The palette 60 is formed of an opaque material to serve as a background so that images or characters printed on the bottom of the transparent discharging plate 70 are more clearly delivered to the consumer.

The transparent discharging plate 70 is formed of a transparent or translucent synthetic resin material, and various images or characters to be delivered to the consumer are printed on the bottom of the transparent discharging plate 70.

The palette 60 is formed on a lower side of the transparent discharging plate 70 through an insert-injection molding or a double-injection molding.

In addition, a ring-shaped rim member 61 having a curved inner peripheral surface may be formed on the upper side of the transparent discharging plate 70 through an insert-injection molding or a double-injection molding, in which the rim member 61 serves to prevent the cosmetic material from flowing down to the outside of the transparent discharging plate 70 when the cosmetic material discharged onto the upper portion of the transparent discharging plate 70 is rubbed by the puff.

Preferably, the rim member 61 and the palette 60 may be simultaneously formed onto the transparent discharging plate 70 through the insert-injection molding or double-injection molding.

The transparent discharging plate 70 is formed therein with discharging holes 72 for discharging the cosmetic material, which is passed through the distribution passage 52 of the distribution plate 50 and the discharging passage 62 of the palette 60, to the outside.

After the transparent discharging plate 70 and the palette 60 are formed through the insert-injection molding or double-injection molding, the discharging holes 72 of the transparent discharging plate 70 and the discharging passage 62 of the palette 60 may be drilled or punched by a press or a laser.

Alternately, after the discharging holes 72 of the transparent discharging plate 70 are drilled or punched by the press or the laser in advance, the transparent discharging plate 70 and the palette 60 may be formed through the insert-injection molding or double-injection molding while forming the discharging passages 62 in accordance with positions of the discharging holes 72.

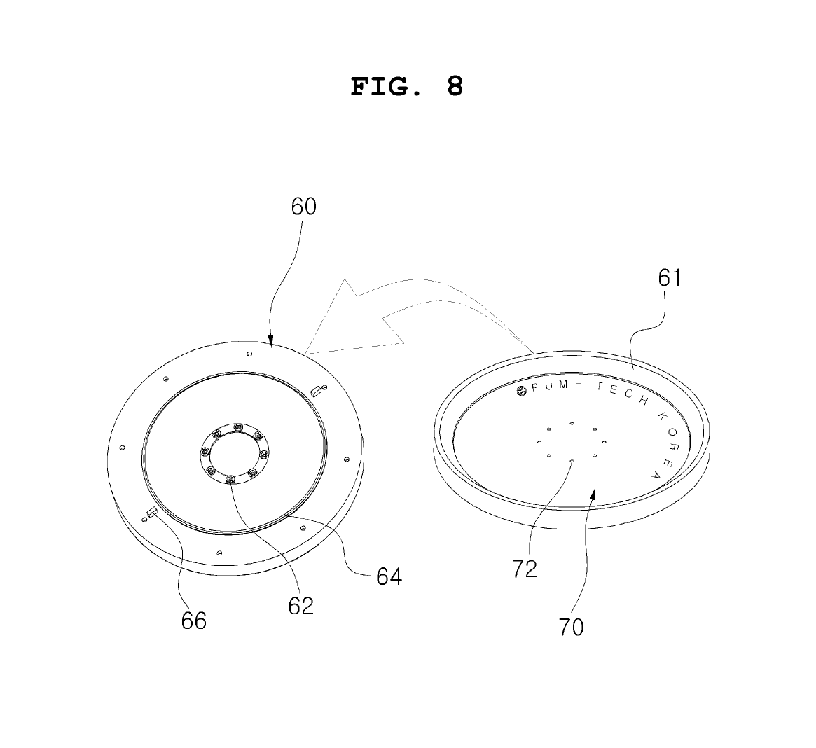

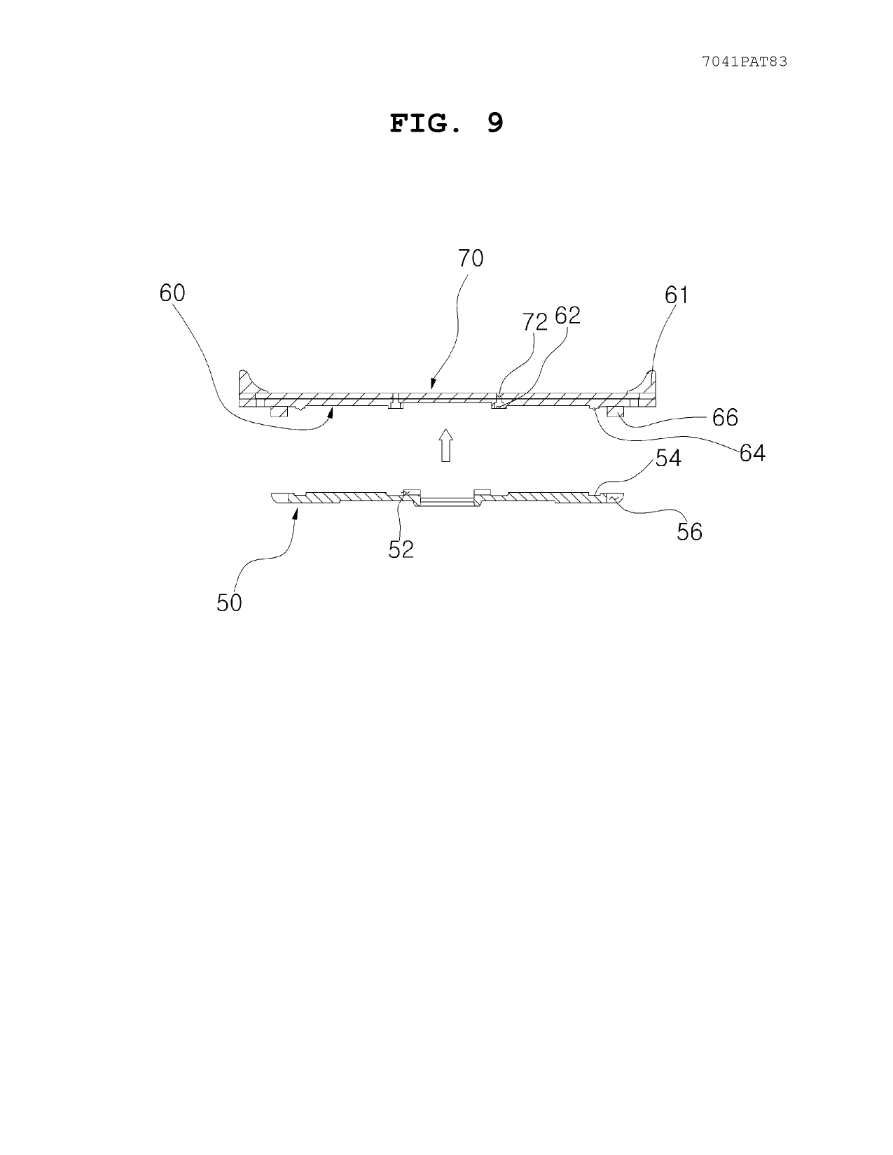

FIG. 8 is a sectional view showing a state a palette, a rim member, and a transparent discharging plate are insert-injected or double-injected of a compact container having a transparent discharging plate for providing an information delivery function and preventing foreign substances from infiltrating into a bottom thereof according to the present invention. FIG. 9 is a sectional view showing a state of a distribution plate coupled to a lower side of the palette of a compact container having a transparent discharging plate for providing an information delivery function and preventing foreign substances from infiltrating into a bottom thereof according to the present invention.

In other words, various characters or images are printed on the bottom of the transparent plate 70, and the opaque palette 60 is formed on the lower side of the transparent discharging plate 70 through the insert-injection molding or double-injection molding as shown in FIG. 8, thus the various characters or images are projected and displayed on the top of the transparent discharging plate 70 when the compact container is opened as shown in FIG. 3. Accordingly, information on the compact being used can be delivered to the consumer, the aesthetics can be visually improved, and the characters or images can be prevented from being contaminated by the discharged cosmetic material.

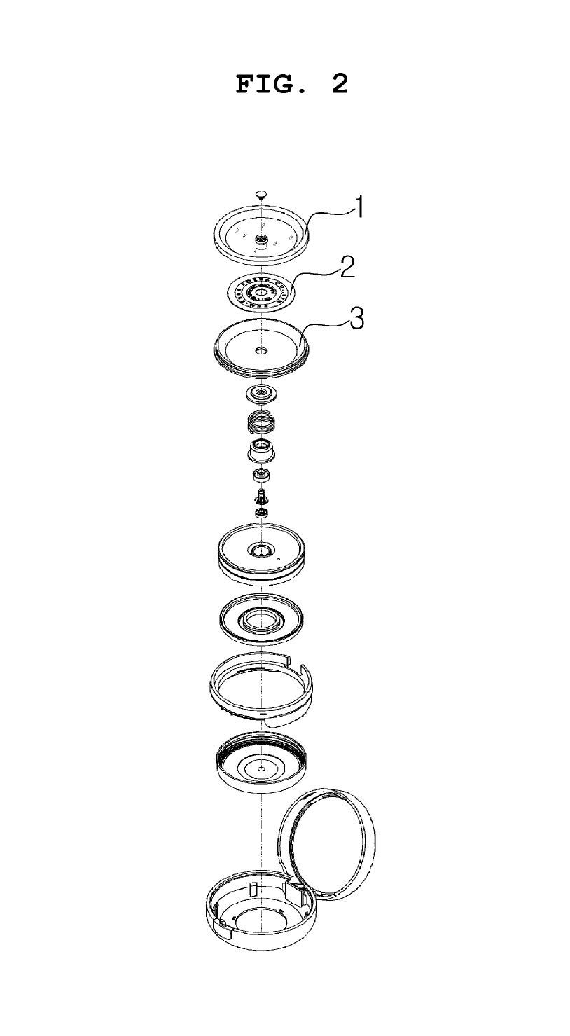

In the conventional compact container, as shown in FIG. 2, when, the cosmetic material is discharged, the cosmetic material infiltrates into a gap between the transparent discharging plate 1 and the information delivery plate 3 assembled with the transparent discharging plate 1, thus patterns or characters printed on the information delivery plate 3 are covered by the cosmetic material. Thus, there are problems in that the information delivery function is insufficiently performed, it becomes, dirty visually, and an assembly process for inserting the information delivery plate 3 is increased, lowering the productivity.

According to the present invention, the characters or images are directly printed on the transparent discharging plate, and the palette 60 is farmed on the lower side of the transparent discharging plate 70 through the insert-injection molding or the double-injection molding, thereby removing the clearance between the transparent discharging plate 70 and the palette 60, such that the cosmetic material discharged by the discharging device 40 is prevented from infiltrating between the transparent discharging plate 70 and the palette 60.

Further, according to the present invention, as shown in FIG. 9, the distribution plate 50 is bonded to the lower side of the transparent discharging plate 70 and the palette 60 which are formed through the insert-injection molding or double-injection molding, thereby forming, one component coupled to the upper portion of the discharging device 40, thus an assembly structure of the compact container is simplified, improving the productivity.

Hereinafter, a method of assembling the above compact container having a transparent discharging plate for providing an information delivery function and preventing foreign substances from infiltrating into a bottom thereof will be described with reference to the accompanying drawings.

In order to assemble the compact container having a transparent discharging plate for providing an information delivery function and preventing foreign substances from infiltrating into a bottom thereof according to the present invention, at first, as shown in FIGS. 4 and 5, the contents container 30 is inserted into the outer container 10 hinged to one side thereof with the outer container lid 20.

Next, the lifting plate 38 is fitted into the contents container 30, the cosmetic material is injected, and the pump housing 41 of the discharging device 40 is coupled to the upper portion of the contents container 30, such that the lower extending protrusion wheel 414 of the pump housing 41 is fitted and coupled between the inner wall 34 and the outer wall 36 of the contents container 30.

Next, the suction valve plate 43, the bushing 44, the elastic member 46, the piston 47, the piston ring 49, and the up/down moving member 45 are mounted on the upper portion of the pump housing 41.

Next, the distribution plate 50, the palette 60 and the transparent discharging plate 70 are coupled to the top of the up/down moving member 45 of the discharging device 40.

At this point, as shown in FIG. 8, the rim member 61 and the palette 60 are formed on the upper and lower sides of the transparent discharging plate 70, respectively, through the insert-injection molding or double-injection molding, and as shown in FIG. 9, the distribution plate 50 is bonded to the lower side of the palette 60 and formed into a single component, thereby being coupled to the up/down moving member 45 of the discharging device 40. Therefore, the assembling structure of the compact container is simplified, thereby improving the productivity.

Next, the coupling shoulder 80 is inserted and coupled between the outer container 10 and the contents container 30. The coupling protrusion 14 of the outer container 10 is coupled to the coupling groove 84 of the coupling shoulder 80, and simultaneously, the upper end of the fix protrusion wheel 416 of the pump housing 41 is pressed and fixed by the pressing sill 86 of the coupling shoulder 80, thereby finishing the assembly of the compact container having a transparent discharging plate for providing an information delivery function and preventing foreign substances from infiltrating into a bottom thereof according to the present invention.

Hereinafter, a method of using the compact container, which is assembled through the above method and has a transparent discharging plate for providing an information delivery function and preventing foreign substances from infiltrating into a bottom thereof, will be described with reference to the accompanying drawings.

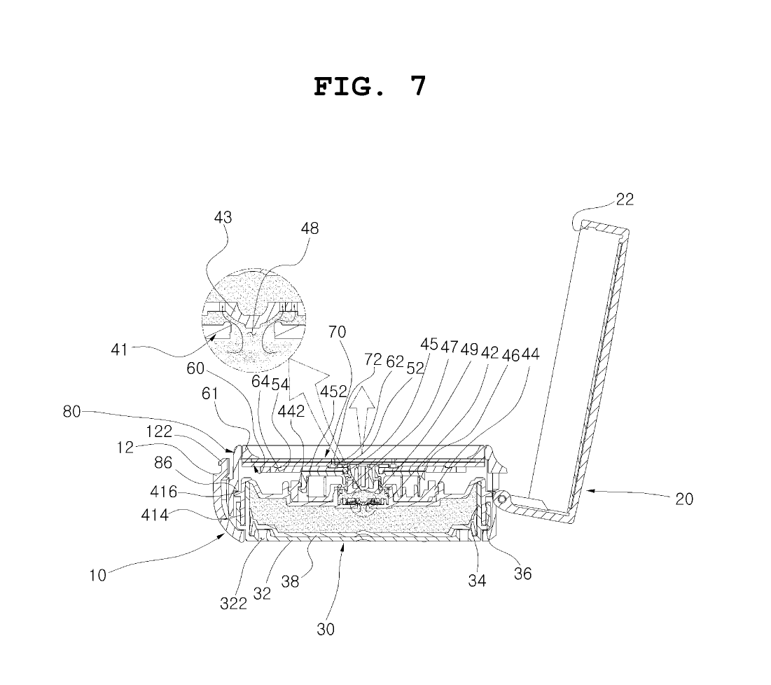

FIG. 5 is a sectional view showing a state of discharging a cosmetic material onto a transparent discharging plate of a compact container having a transparent discharging plate for providing an information delivery function and preventing foreign substances from infiltrating into a bottom thereof according to the present invention. FIG. 7 is a sectional view showing a state of introducing a cosmetic material into a cylinder of a compact container having a transparent discharging plate for providing an information delivery function and preventing foreign substances from infiltrating into a bottom thereof according to the present invention.

In order to use the compact container having a transparent discharging plate for providing an information delivery function and preventing foreign substances from infiltrating into a bottom thereof according to the present invention, first, the outer container lid 20 is opened by pressing the button 12 of the outer container 10.

When the outer container lid 20 is opened, as shown in FIG. 3, the images or characters printed on the bottom of the transparent discharging plate 70 are projected on the top the transparent discharging plate 70 and delivered to the consumer.

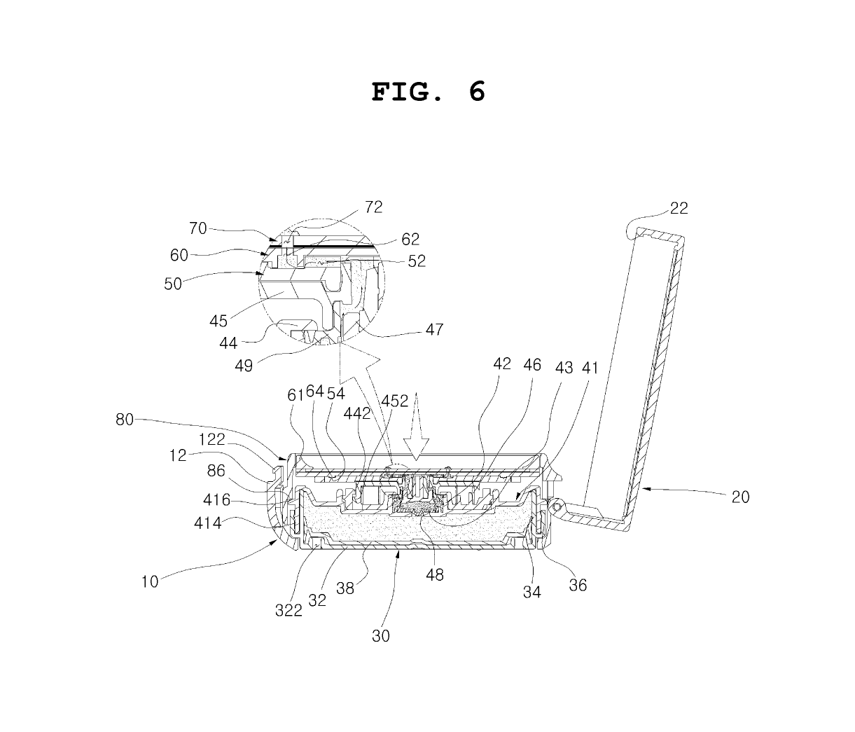

Next, as shown in FIG. 6, the upper surface of the transparent discharging plate 70 is pressed with a makeup tool such as a puff.

When the transparent discharging plate 70 is pressed.

the palette 60 insert-injection molded or double-injection molded with the transparent discharging plate 70 and the distribution plate 50 bonded to the lower side of the palette 60 are also moved downwardly, while the up/down moving member 45, the piston 47 and the piston ring 49 coupled to the lower side of the distribution plate 50 are moved downwardly together, so that the volume inside the cylinder 42 is reduced.

Accordingly, a pressure is generated inside the cylinder 42, and a discharging pressure is generated as the cosmetic material in the cylinder 42 tends to be discharged to the outside due to the pressure, so that the suction valve plate 43 closes the contents suction hole 48 formed on the bottom surface of the cylinder 42.

Simultaneously, as shown in the enlarged view of FIG. 6, the cosmetic material accommodated in the cylinder 42 is discharged between the piston 47 and the piston ring 49, passes through the distribution passage 52 of the distribution plate 50, passes through the discharge passage 62 of the palette 60, and is discharged to the discharging holes 72 of the transparent discharging plate 70.

At this point, because the palette 60 is formed on the lower side of the transparent discharging plate 70 through the insert-injection molding or the double-injection molding to remove the clearance between the transparent discharging plate 70 and the palette 60, the cosmetic material discharged by the discharging device 40 is prevented from being infiltrated between the transparent discharging plate 70 and the palette 60.

Then, as shown, in FIG. 7, when the pressing of the transparent discharging plate 70 is released, the distribution plate 50 is moved upward by the elasticity of the elastic member 4 6 for elastically supporting the distribution plate 50, while the up/down moving member 45, the piston 47 and the piston ring 49 coupled to the lower side of the distribution plate 50 are moved upwardly together, thus the volume inside the cylinder 42 is increased, thereby generating a vacuum pressure.

Simultaneously, the suction valve plate 43 is lifted by the vacuum pressure generated inside the cylinder 42, thereby opening the contents suction hole 48 formed on the bottom surface of the cylinder 42, thus the cosmetic material accommodated in the contents container 30 is introduced into the cylinder 42 through the contents suction hole 48, while the lifting plate 38 installed in the contents container 30 moves upwardly.

The present invention described in the above is just one embodiment for carrying out a compact container having a transparent discharging plate for providing an information delivery function and preventing foreign substances from infiltrating into a bottom thereof, and the present invention is not limited thereto. Preferable embodiments have been proposed and set forth in the aforementioned description, however it will be apparent to those having ordinary skill in the art in that many different substitutions, deformations and modifications are available within the scope without departing from the invention.

What is claimed is:

1. A compact container having a transparent discharging plate for providing an information delivery function and preventing foreign substances from infiltrating, into a bottom of the transparent discharging plate, the compact container comprising:
a distribution plate (50) provided, therein with a distribution passage (52);
a palette (60) formed on a top of the distribution plate (50), and provided therein with a discharging passage (62); and
the transparent discharging plate (70) formed on an upper portion, of the pallet (60), provided therein with discharging holes (72), and formed of a transparent or translucent material, wherein
images or characters are printed on the bottom, of the transparent discharging plate (70) and projected onto a top of the transparent discharging plate (70), the palette (60) is formed on a lower side of the transparent discharging plate (70) through an insert-injection molding of a double-injection molding, and the distribution plate (50) is coupled to a lower side of the palette (60), thereby forming a single component.

2. The compact container of claim 1, wherein the distribution plate (50), the palette (60) and the transparent discharging plate (70) are adjacently coupled to a discharging device (40) for discharging a cosmetic material accommodated in a contents container (30).

3. The compact container of claim 2, wherein the discharging device (40) includes a pump for pumping the cosmetic material.

4. The compact container of claim 1, wherein the distribution plate (50) is formed on an upper surface thereof with a fitting annular groove (54) and a fitting groove (56), and the palette (60) is formed on a lower surface thereof with a fitting protrusion wheel (64) and a fitting protrusion (66), so that the fitting protrusion wheel (64) is fitted into the fitting annular groove (54), and the fitting protrusion (66) is fitted into the fitting groove (56).

5. The compact container of claim 1, wherein the distribution plate (50) is bonded to the lower side of the palette (60) through ultrasonic bonding, RF bonding or thermal bonding, bonded to the lower side of the palette (60) by an adhesive, or undercut-coupled to the lower side of the palette (60).

6. The compact container of claim 1, wherein the palette (60) is formed of an opaque material.

7. The compact container of claim 1, wherein the transparent discharging plate (70) is formed on an upper side thereof with a rim member (61) which is formed onto the transparent discharging plate (70) through an insert-injection molding or a double-injection molding simultaneously with the palette (60).
